(19) United States
(12) Patent Application Publication
(10) Pub. No.: US 2003/0079900 A1
(43) Pub. Date: May 1, 2003

(54) Adjustable line length

(76) Inventors: Scott D. Hahn, Boise, ID (US); Freddie Wayne Smith, Boise, ID (US); Edward Michael Wood, Boise, ID (US); Carrie L. Claflin, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/983,797

(22) Filed: Oct. 25, 2001

(51) Int. Cl. H01B 7/06

(52) U.S. Cl. 174/69

(57) ABSTRACT

An electrical conductor having an adjustable length is provided comprising a first conducting segment, a second conducting segment, and at least one conducting extension having a first end and a second end. The electrical conductor can be configured in a first configuration such that the first conducting segment is directly connected to the second conducting segment, and can be configured in a second configuration such that the first conducting segment is connected to the first end of the at least one conducting extension and the second conducting segment is connected to the second end of the at least one conducting extension.

### FIELD OF THE INVENTION

The invention relates to selectably delaying an electrical signal propagating along a conductive segment. In particular, the invention relates to a an adjustable line length between circuit components on a circuit board.

### BACKGROUND

Electrical circuits have been used for years to process data in devices ranging from common cell phones to advanced telecommunication boxes. Data signals with corresponding clock signals are processed by a variety of circuit components on these boards, each circuit component performing a specific function on the data signals. It is important, however, that the electrical signals propagating between circuit components are properly aligned with each other to reduce processing errors, for example improper clock to data synchronization which can directly lead to bit errors and data corruption. Thus, it is important that an engineer be able to manipulate the electrical signal alignment to improve upon circuit board performance.

Conventional systems employ a variety of techniques to obtain proper electrical signal alignment. One such method utilizes an integrated circuit delay device, such as Dallas Semiconductor part number DS1023, comprising passive filtering components (e.g., capacitors, inductors, etc.) and CMOS gates to induce a calculated delay on an electrical signal. Integrated circuit delay devices, however, tend to be expensive and adversely affect electrical signal properties such as rise and fall edge characteristics, overshoot, undershoot and other electrical signal properties as would be readily apparent to one skilled in the art. Furthermore, integrated circuit delay components have limitations on the minimum delay they can produce, which is typically several nanoseconds or greater. Moreover, the delay induced by an integrated circuit delay component is often fixed (e.g., non-adjustable), which does not provide an engineer with the ability to adjust signal delay as needed once a particular chip is selected.

Another method utilizes discrete passive components (e.g., capacitors, inductors, etc.) to construct delay circuits on a printed circuit board. This method typically increases the part count and expense of manufacturing the circuit board. Furthermore, this method also adversely affects electrical signal properties such as those previously described.

Thus, a need exists for generating an electrical signal delay that does not require expensive integrated circuit devices and/or eliminates the use of passive filtering components to induce electrical signal delay.

### SUMMARY OF THE INVENTION

The present invention is directed to overcoming or at least reducing the effects of one or more of the problems set forth above and other problems in the prior art.

According to one aspect of the present invention, an electrical conductor having an adjustable length is provided comprising a first conducting segment, a second conducting segment, and at least one conducting extension having a first end and a second end. The electrical conductor can be configured in a first configuration such that the first conducting segment is directly connected to the second conducting segment, and the electrical conductor can be configured in a second configuration such that the first conducting segment is connected to the first end of the at least one conducting extension and the second conducting segment is connected to the second end of the at least one conducting extension.

In a preferred aspect of the invention, the length of the at least one conductive extension corresponds to a selectable delay of an electrical signal propagating via the electrical conductor.

According to another aspect of the present invention, the at least one conducting extension comprises at least one conductive serpentine segment.

According to another aspect of the present invention, the at least one conducting extension comprises a first conducting extension having a first end and a second end and a second conducting extension having a first end and a second end, the electrical conductor can be configured in a second configuration such that the first conducting segment is connected to the first end of the first conducting extension and the second conducting segment is connected to the second end of the first conducting extension, and the electrical conductor can be configured in a third configuration such that the first conducting segment is connected to the first end of the second conducting extension and the second conducting segment is connected to the second end of the second conducting extension.

According to another aspect of the present invention, the electrical conductor further comprises a first jumper connected to the first conducting segment, a second jumper connected to the second conducting segment, a third jumper connected to the first end of the at least one conducting extension, and a fourth jumper connected to the second end of the at least one conducting extension. The electrical conductor is configured in the first configuration by connecting the first jumper with the second jumper, and the electrical conductor is configured in the second configuration by connecting the first jumper with the third jumper and the second jumper with the fourth jumper. Preferably, the jumpers each comprise a low impedance non-filtering element.

According to another aspect of the present invention, the first conducting segment, the second conducting segment, and the at least one conductive extension each comprise a conductive trace.

According to yet another aspect of the present invention, a method of delaying an electrical signal propagating via an electrical conductor is provided comprising the steps of selecting at least one from a plurality of pre-wired conductive extensions based on a criteria, and connecting the electrical conductor to the at least one selected conductive extension.

According to another aspect of the present invention, the step of connecting the electrical conductor to the at least one selected conductive extension is performed by connecting a plurality of jumpers with at least one of wires, solder bridges, switches and resistors. Preferably, the jumpers each comprise a low impedance non-filtering element.

According to yet another aspect of the present invention, a circuit board including an adjustable electrical conductor for selectively delaying an electrical signal propagating via the adjustable electrical conductor is provided comprising a first default trace having an input connected to an electrical signal source and an output connected to a jumper, a second default trace having an input connected to a jumper and an output, a first delay trace having an input connected to a first jumper and an output connected to a second jumper, and a second delay trace having an input connected to a first jumper and an output connected to a second jumper. The circuit board can be operated in a first delay configuration such that the jumper of the first default trace is electrically connected to the first jumper of the first delay trace and the jumper of the second default trace is electrically connected to the second jumper of the first delay trace. The circuit board can be operated in a second delay configuration such that the jumper of the first default trace is electrically connected to the first jumper of the second delay trace and the jumper of the second default trace is electrically connected to the second jumper of the second delay trace. The circuit board can be operated in a third delay configuration such that the jumper of the first default trace is electrically connected to the first jumper of the first delay trace, the second jumper of the first delay trace is electrically connected to the first jumper of the second delay trace, and the second jumper of the second delay trace is electrically connected to the jumper of the second default trace.

### BRIEF DESCRIPTION OF THE DRAWINGS

In the following, the invention will be explained in further detail with reference to the drawings, in which:

FIG. 1A is a schematic diagram of a first configuration of an adjustable electrical conductor according to the present invention.

FIG. 1B is a schematic diagram of a second configuration of an adjustable electrical conductor according to the present invention.

FIG. 2 is a schematic diagram of a printed circuit board including an adjustable electrical conductor according to the present invention.

FIG. 3 is a schematic diagram of a circuit board including an adjustable electrical conductor with resistor (“R”) connections according to the present invention.

FIG. 4 is a schematic diagram of a circuit board including an adjustable electrical conductor with switch (“SW”) connections according to the present invention.

FIG. 5 is a schematic diagram of a circuit board including an adjustable electrical conductor with wire jumper (“J”) connections according to the present invention.

### DESCRIPTION OF CERTAIN EMBODIMENTS OF THE INVENTION

According to one aspect of the present invention, an electrical conductor can be designed with parameters selected to correspond to a specific propagation delay of an electrical signal using equations that approximate the time it takes for an electrical signal to propagate a given distance along a conductive segment (e.g., a wire, circuit board trace, etc.). By way of example but not by way of limitation, exemplary equations can be found in I. J. Bahl & Ramesh Garg, Simple And Accurate Formulas For Microstrip With Finite Strip Thickness, Proc. IEEE, 65 (1977), at 1611 and T. C. Edwards, Foundations of Microstrip Circuit Design, John Wiley, New York (1981) which are incorporated by reference herein in their entirety.

Select equations from Foundations of Microstrip Circuit Design are provided below for illustrative purpose only. These equations are primarily used to approximate the impedance of a given electrical conductor, and can be used to design a trace that correlates to a desired delay of an electrical signal propagating along that electrical conductor. For these equations, h=trace height from a ground plane (inch), w=trace width (inch), t=trace thickness (inch), x=trace length (inch) and er=relative permittivity of material between the trace and the ground plane. In the first set of equations listed below, the effective relative permittivity as a function of microstrip trace geometry is approximated. The permittivity is required in later formulas to approximate the effective trace width, which in turn is used to approximate the effective impedance of the trace.

For traces where w≦h (“skinny traces” hereinafter):

$$E\_skny ( h , w , e r ) := \frac{e r + 1}{2} + ( \frac{e r - 1}{2} ) \cdot [ {( 1 + \frac{12 \cdot h}{w} )}^{- .500} + .04 \cdot {( 1 - \frac{w}{h} )}^{2} ]$$

For traces where w>h (“wide traces” hereinafter):

$$E\_wide ( h , w , e r ) := \frac{e r + 1}{2} + ( \frac{e r - 1}{2} ) \cdot {( 1 + \frac{12 \cdot h}{w} )}^{- .500}$$

For picking skinny or wide model depending on w/h ratio:

E_temp(h, w, er):=if(w>h, E_wide(h, w, er), E_skny(h, w, er))

Formula for adjusting to account for t:

$$E E F F ( h , w , t , e r ) := E\_temp ( h , w , e r ) - \frac{( e r - 1 ) \cdot ( \frac{t}{h} )}{4.6 \cdot \sqrt{\frac{w}{h}}}$$

When the w/h ratio depicts a skinny model, the calculation results in approximately the average of the printed circuit board (PCB) permittivity, er, and the permittivity of air. When the w/h ratio depicts a wide model (e.g., the trace is very close to the ground plane), the calculation results in approximately the average of the PCB permittivity, er. The effective trace width can then be approximated from the following equations:

For skinny traces:

$$WE\_skny ( h , w , t ) := w + \frac{1 \cdot 25 \cdot t}{π} \cdot ( 1 + ln ( \frac{4 \cdot π \cdot w}{t} ) )$$

For wide traces:

$$WE\_wide ( h , w , t ) := w + \frac{1 \cdot 25 \cdot t}{π} \cdot ( 1 + ln ( \frac{2 \cdot h}{t} ) )$$

For picking skinny or wide model depending on w/h ratio:

$$W E ( h , w , t ) := if ( w > \frac{h}{2 \cdot π} , WE\_wide ( h , w , t ) , WE\_skny ( h , w , t ) )$$

The effective trace width as calculated from the equations above can then be used to approximate the effective impedance of the trace. Thus, the characteristic impedance as a function of trace geometry can be approximated from the following equations:

For skinny traces:

$$ZMS\_skny ( h , w , t ) := 60 \cdot ln ( \frac{8 \cdot h}{W E ( h , w , t )} + \frac{W E ( h , w , t )}{4 \cdot h} )$$

For wide traces:

$$ZMS\_wide ( h , w , t ) := \frac{120 \cdot π}{\frac{W E ( h , w , t )}{h} + 1.393 + .667 \cdot ln ( \frac{W E ( h , w , t )}{h} + 1.444 )}$$

For picking skinny or wide model depending on w/h ratio:

$$ZMSTRIP ( h , w , t , e r ) := \frac{i f ( w > h , ZMS\_wide ( h , w , t ) , ZMS\_skny ( h , w , t ) )}{\sqrt{EEFF ( h , w , t , er )}}$$

Standard equations that are well known in the art can then be used to design a trace having the above approximated impedance correlating to a desired electrical signal delay, such as the following equation where c=speed of light and l=length of trace:

$$delay ( l , EEFF ( h , w , t , e r ) ) := \frac{l}{\frac{c}{\sqrt{EEFF ( h , w , t , er )}}}$$

Thus, one aspect of the present invention is the ability to design a plurality of extension traces that each correspond to an approximate delay of an electrical signal propagating along a selected extension.

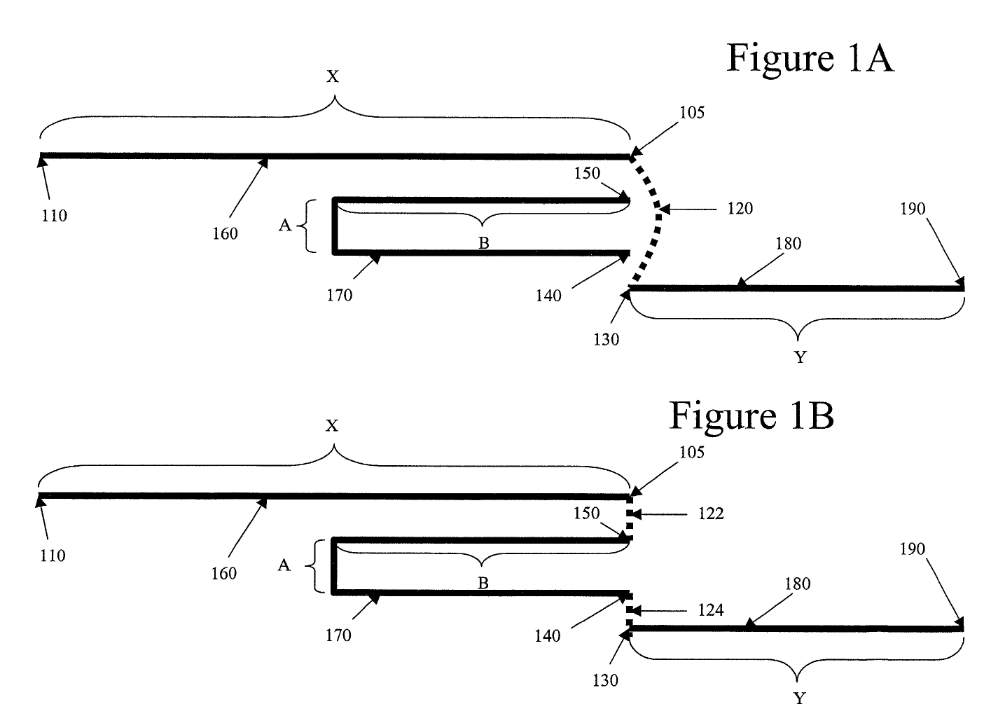

A first embodiment of electrical conductor having an adjustable length according to the present invention is shown by the schematics of FIG. 1A and FIG. 1B. As shown, the electrical conductor comprises a first conducting segment 160 having a first end 110 and a second end 105, a second conducting segment 180 having a first end 130 and a second end 190, and at least one conducting extension 170 having a first end 150 and a second end 140. It should be appreciated that ends 110, 105, 130, and 190 do not necessarily have to be placed exactly at an end point of the respective segments. The ends may be located at some distance along the respective segments as may be required in some implementations of the present invention. Similarly, the extension 170 may comprise a plurality of ends (not shown) along the extension to allow for a configurable single extension length. Thus, the term “end” is intended to be broader than an end point.

As shown in FIG. 1A, the electrical conductor is configured in a first configuration such that the first conducting segment 160 is directly connected via connection 120 to the second conducting segment 180. For illustrative purposes only, the first conducting extension 160 has an approximate length of X, the second extension 180 has an approximate length of Y, and the extension 170 has an approximate length of A+2B. In this first configuration, the net length of the electrical conductor is approximately X+Y, assuming the connection 120 to be of insignificant length.

As shown in FIG. 1B, the electrical conductor is configured in a second configuration such that the first conducting segment 160 is directly connected via connection 122 to the first end 150 of the extension 170, and the second conducting segment 180 is directly connected via connection 124 to the second end 140 of the extension 170. In this second configuration, the net length of the electrical conductor is approximately X+A+2B+Y, assuming the connections 122 and 124 to be of insignificant length. Thus, the electrical conductor has an overall length that is longer by A+2B in the second configuration than in the first configuration.

As shown, the extension 170 comprises a substantially “U” shaped serpentine segment. Other configurations such as “S” shaped serpentine segments, “Z” shaped serpentine segments, and other serpentine segments as well as non-serpentine segments can be utilized as would be readily apparent to one skilled in the art. A serpentine segment is preferred due to the relatively high length in relation to overall cross-sectional area covered.

Connections 120, 122, and 124 can be achieved using any number of conventional electrical connecting methods. Preferably, connections 120, 122, and 124 are performed using low impedance non-filtering elements to reduce the adverse effects of high impedance elements in passive components. Wires, solder bridges, switches and resistors, for example, are suitable elements that can be used for connections 120, 122, and 124.

Preferably, conductive segments 160, 180 and extension 170 each comprise a conductive trace as is commonly used in printed circuit boards (“PCB” hereinafter). Conductive segments 160, 180 and extension 170 may comprise other elements such as conductive wire, or other elements as would be readily apparent to one skilled in the art.

As previously described, an electrical signal propagating along an electrical conductor can be delayed by increasing the length of the electrical conductor, which requires the electrical signal to propagate a greater distance thereby inducing a delay on the electrical signal. Thus, an electrical conductor according to this first embodiment having a total length adjustable by A+2B has the advantage of providing an adjustable electrical signal delay without requiring an integrated circuit delay device, and/or any substantial passive components that could adversely affect electrical signal properties. Furthermore, an electrical conductor according to this first embodiment is configurable, in that the delay can be induced or removed by easily changing configurations, and can further be adjusted by providing a plurality of extensions (not shown).

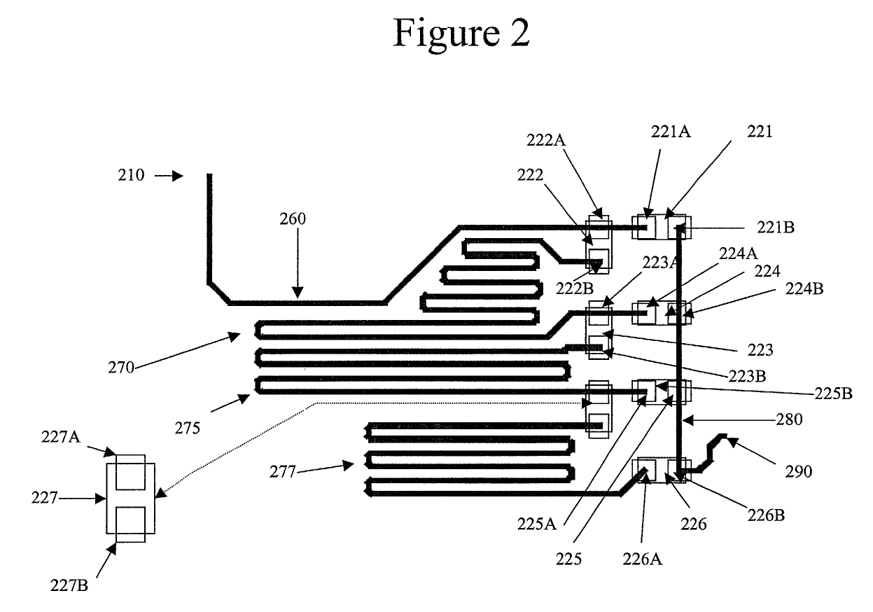

A second embodiment of electrical conductor having an adjustable length according to the present invention is shown by the schematic of FIG. 2. For purposes of illustration, jumper 227 is shown enlarged in the lower left hand corner of FIG. 2. The jumper 227 comprises a first conductor attachment point 227A and a second conductor attachment point 227B. It should be appreciated that jumpers 221, 222, 223, 224, 225, 226, and 227 all have a similar configuration.

According to this second embodiment, a PCB comprises a first default trace 260 having an input 210 connected to an electrical signal source (not shown) and an output connected to jumper 222 (at 222A) or jumper 221 (at 221A), a second default trace 280 having an input connected to a jumper 221 (at 221B), jumper 224 (at 224B), jumper 225 (at 225B), or jumper 226 (at 226B) and an output 290, and a plurality of serpentine delay traces 270, 275, and 277.

First delay trace 270 has an input connected to a first jumper 222 (at 222B) and an output connected to a second jumper 223 (at 223A) or jumper 224 (at 224A). Second delay trace 275 has an input connected to a first jumper 223 (at 223B) and an output connected to a second jumper 225 (at 225A) or jumper 227 (at 227A). Third delay trace 277 has an input connected to a first jumper 227 (at 227B) and an output connected to a second jumper 226 (at 226A). As shown, delay traces 270, 275, and 277 are preferably of unequal lengths.

A PCB according to this second embodiment can be operated in a default configuration such that jumper 221 is installed, thereby providing a non-delayed connection from input 210 to output 290.

A PCB according to this second embodiment can also be operated in a first delay configuration such that jumpers 222, 224 are installed and jumper 221 is not installed, thereby including a first delay path (i.e., 270).

A PCB according to this second embodiment can further be operated in a second delay configuration such that jumpers 222, 223, and 225 are installed and jumpers 221 and 224 are not installed, thereby including two delay paths (i.e., 270 and 275) from input 210 to output 290.

A PCB according to this second embodiment can further be operated in a third delay configuration such that jumpers 222, 223, 227, and 226 are installed and jumpers 221, 224, and 225 are not installed, thereby including three delay paths (i.e., 270, 275, and 277) from input 210 to output 290.

As would be readily apparent to one skilled in the art, other delay configurations can also be implemented. Thus, the aforementioned configurations were provided as examples only, and are not limiting on the scope of the invention.

A PCB according to this second embodiment has all of the aforementioned advantages of the first embodiment, and further provides for a wide range of available configurations. Thus, an engineer would have many possible delay configurations to choose from, thereby allowing for a high degree of adjustability which could not be achieved with conventional systems. Preferably, the traces 260, 270, 275, 277, and 290 each comprise a copper trace approximately seven mils in width as is commonly used in conventional PCB boards to reduce the cost of manufacturing.

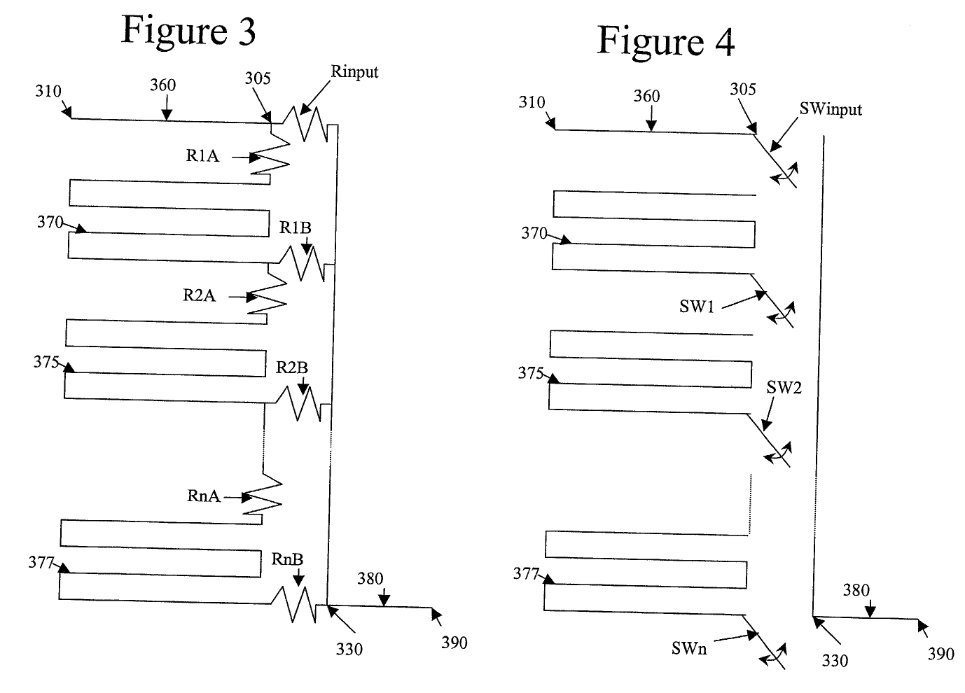

In any one of the aforementioned embodiments jumper wires (“W”), switches (“SW”) and/or resistors (“R”) and specific combinations thereof are suitable elements that can be used for connecting a first conductive segment 360 having an input 310 and an end 305 to a second conductive segment 380 having an output 390 and an end 330 via selectable conducting extensions 370, 375, and 377. FIGS. 3-5 depict exemplary implementations with each of the aforementioned connection schemes respectively.

As shown in FIG. 3, two resistors R_A and R_B per extension 370, 375, and 377 are used to selectably connect to each of the delay extensions. Preferably, the resistors have a resistance value that is sufficiently low to not adversely affect electrical signal properties. Most preferably, the resistors have a resistance less than 5% of the designed trace impedance. A resistor value of 20 mΩ such as part no. CRCWO60300 manufactured by Vishay Intertechnology is one typically acceptable resistor.

As shown in FIG. 4, one switch per extension 370, 375, and 377 is used to selectably connect to each of the delay extensions. The switches can be electrically controllable switches to allow an external source such as a computer (not shown) to automatically select various extensions based on a criteria. Switches such as part no. 97C06S manufactured by Grayhill Inc. are suitable for the present invention.

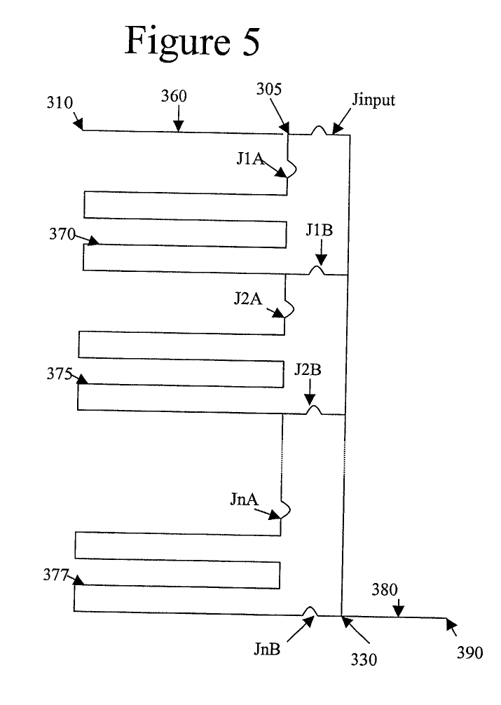

As shown in FIG. 5, two wire jumpers J_A and J_B per extension 370, 375, and 377 are used to selectably connect to each of the delay extensions. Conventional wire jumpers have a negligible resistance value compared to the traces they connect, and would thus not adversely affect electrical signal properties.

The above referenced connection schemes as shown in FIGS. 3-5 allow for relatively simple configuration of any one of the aforementioned embodiments. As the components utilized are common in the industry, cost savings can also be achieved over implementations using complex and/or proprietary interconnectors. The connection schemes depicted in FIGS. 3-5 are intended to be exemplary only, and are not limiting on the scope of the present invention. As would be readily apparent to one skilled in the art, other connection schemes may also be utilized.

The foregoing description of a preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined the claims appended hereto, and their equivalents.

What is claimed is:

1. An electrical conductor having an adjustable length, comprising:
a first conducting segment;
a second conducting segment; and
at least one conducting extension having a first end and a second end,
wherein said electrical conductor can be configured in a first configuration such that said first conducting segment is directly connected to said second conducting segment, and
wherein said electrical conductor can be configured in a second configuration such that said first conducting segment is connected to said first end of said at least one conducting extension and said second conducting segment is connected to said second end of said at least one conducting extension.

2. The electrical conductor of claim 1, wherein the at least one conducting extension comprises at least one conductive serpentine segment.

3. The electrical conductor of claim 1, wherein the at least one conducting extension comprises a first conducting extension having a first end and a second end and a second conducting extension having a first end and a second end, wherein said electrical conductor can be configured in said second configuration such that said first conducting segment is connected to said first end of said first conducting extension and said second conducting segment is connected to said second end of said first conducting extension, and wherein said electrical conductor can be configured in a third configuration such that said first conducting segment is connected to said first end of said second conducting extension and said second conducting segment is connected to said second end of said second conducting extension.

4. The electrical conductor of claim 3, wherein said electrical conductor can be configured in a fourth configuration such that said first conducting segment is connected to said first end of said first conducting extension, said second end of said first conducting extension is connected to said first end of said second conducting extension, and said second conducting segment is connected to said second end of said second conducting extension.

5. The electrical conductor of claim 1, further comprising:
a first jumper connected to said first conducting segment;
a second jumper connected to said second conducting segment;
a third jumper connected to said first end of said at least one conducting extension; and
a fourth jumper connected to said second end of said at least one conducting extension,
wherein said electrical conductor is configured in said first configuration by connecting said first jumper with said second jumper, and
wherein said electrical conductor is configured in said second configuration by connecting said first jumper with said third jumper and said second jumper with said fourth jumper.

6. The electrical conductor of claim 5, wherein said jumpers each comprise a low impedance non-filtering element.

7. The electrical conductor of claim 1, wherein said first conducting segment, said second conducting segment, and said at least one conductive extension each comprise a conductive trace.

8. The electrical conductor of claim 7, comprising at least one of wires, solder bridges, switches and resistors for connecting each conductive trace.

9. The electrical conductor of claim 1, wherein said first conducting segment, said second conducting segment, and said at least one conductive extension each comprise a conductive wire.

10. The electrical conductor of claim 1, wherein the length of the at least one conductive extension corresponds to a selectable delay of an electrical signal propagating via said electrical conductor.

11. A method of delaying an electrical signal propagating via an electrical conductor comprising the steps of: selecting at least one from a plurality of pre-wired conductive extensions based on a criteria; and connecting said electrical conductor to said at least one selected conductive extension.

12. The method of claim 11, wherein said plurality of conductive extensions each comprise at least one conductive serpentine segment.

13. The method of claim 11, wherein the step of connecting said electrical conductor to said at least one selected conductive extension is performed by connecting a plurality of jumpers.

14. The method of claim 13, wherein the step of connecting said electrical conductor to said at least one selected conductive extension is performed by connecting said plurality of jumpers with at least one of wires, solder bridges, switches and resistors.

15. The method of claim 13, wherein said jumpers each comprise a low impedance non-filtering element.

16. The method of claim 13, wherein the electrical conductor comprises a conductive trace.

17. The met hod of claim 11, wherein the electrical conductor comprises a conductive wire.

18. The method of claim 11, wherein the criteria is a length corresponding to a signal delay.

19. A circuit board including an adjustable electrical conductor for selectively delaying an electrical signal propagating via said adjustable electrical conductor, comprising:
a first default trace having an input connected to an electrical signal source and an output connected to a jumper;
a second default trace having an input connected to a jumper and an output;
a first delay trace having an input connected to a first jumper and an output connected to a second jumper; and
a second delay trace having an input connected to a first jumper and an output connected to a second jumper,
wherein the circuit board can be operated in a first delay configuration such that said jumper of said first default trace is electrically connected to said first jumper of said first delay trace and said jumper of said second default trace is electrically connected to said second jumper of said first delay trace,
wherein the circuit board can be operated in a second delay configuration such that said jumper of said first default trace is electrically connected to said first jumper of said second delay trace and said jumper of said second default trace is electrically connected to said second jumper of said second delay trace, and
wherein the circuit board can be operated in a third delay configuration such that said jumper of said first default trace is electrically connected to said first jumper of said first delay trace, said second jumper of said first delay trace is electrically connected to said first jumper of said second delay trace, and said second jumper of said second delay trace is electrically connected to said jumper of said second default trace.

20. The circuit board of claim 19, wherein both the first delay trace and the second delay trace each comprise at least one conductive serpentine trace.

21. The circuit board of claim 19, wherein said jumpers each comprise a low impedance non-filtering element.

22. The circuit board of claim 20, comprising at least one of wires, solder bridges, switches and resistors for electrically connecting each conductive serpentine trace.

23. The circuit board of claim 19, wherein said first default trace, said second default trace, said first delay trace and said second delay trace are each less than seven mils in width.
